(19) United States
(12) Patent Application Publication
(10) Pub. No.: US 2011/0073532 A1
(43) Pub. Date: Mar. 31, 2011

(54) Mechanized Screener

(76) Inventor: Afshin Haghdan, Esfahan (IR)

(21) Appl. No.: 12/850,495

(22) Filed: Aug. 4, 2010

(30) Foreign Application Priority Data
Aug. 16, 2009 (IR) 388050690

(51) Int. Cl. B07B 1/00; B07B 1/46

(52) U.S. Cl. 209/235

(57) ABSTRACT

A mechanized screener including one or more wire mesh screens installed onto a bucket loader. The bucket loader used to scoop up gravel and dirt. While the gravel and dirt is in the bucket loader, the screen separates the gravel from the dirt. The bucket would be a mechanical one that could be operated with a tractor or other road construction machinery.

### CROSS-REFERENCE TO RELATED APPLICATIONS

The present invention claims priority of Iranian patent application number 388050690, Iranian patent number 60599, filed on Aug. 16, 2009, which is incorporated by reference in its entirety.

### FIELD OF THE INVENTION

The subject matter described herein relates to a mechanized screener for separating soil from rocks.

### BACKGROUND

Screeners are used to separate soil from gravel and come in different dimensions and sizes. In use, a bucket loader or mechanical excavator typically feeds mixed soil and gravel to an independent screener. The screener separates the large gravel that has not passed through the screen from the soil that has passed through the screen. In this manner, the large gravel that gathers on top of the screener must be gathered and removed, while the soil below the screener must also be gathered and removed.

Typically, the loader or excavator makes several trips back and forth from the screener. Delivering the mixed soil and gravel requires a number of trips, while removing the filtered soil and gravel also requires additional trips.

This method of filtering soil from large gravel requires a great deal of fuel consumption on the part of the loaders and excavators, it increases the wear and tear that the loaders and excavators are exposed to, and it requires a great deal of time to finish the process of filtering soil from gravel.

### SUMMARY

According to the embodiments of the present invention, a mechanized screener is provided that separates soil from rocks. In the preferred embodiment of the invention, wire mesh is installed on a bucket loader. As the gravel and soil is loaded into the bucket loader, the wire mesh filters the soil from the gravel where the bucket excavator is situated. By accomplishing the filtering where the bucket excavator is situated, there is no need to go back and forth between the excavation site and the location of the screener.

### BRIEF DESCRIPTION OF THE DRAWINGS

The accompanying drawings, which are incorporated into and constitute a part of this specification, illustrate one or more embodiments, and together with the detailed description, serve to explain the principles and implementations of the invention. In the drawings:

FIG. 1 illustrates a top view of a wire mesh in accordance with an embodiment of the present invention.

FIG. 2 illustrates a conceptual side view of the mechanized screener in accordance with an embodiment of the present invention.

FIG. 3 illustrates a conceptual side view of the mechanized screener in accordance with an embodiment of the present invention.

FIG. 4 illustrates a conceptual side view of the mechanized screener in accordance with an embodiment of the present invention.

### DETAILED DESCRIPTION

Embodiments are described herein in the context of a mechanized screener. Those of ordinary skill in the art will realize that the following detailed description is illustrative only and is not intended to be in any way limiting. Other embodiments of the present invention will readily suggest themselves to such skilled persons having the benefit of this disclosure. Reference will now be made in detail to implementations of embodiments of the present invention as illustrated in the accompanying drawings. The same reference indicators will be used throughout the drawings and the following detailed description to refer to the same or like parts.

Embodiments of the mechanized screener have been designed in such a way that it can be installed on a bucket loader or a mechanical excavator. The mechanized screener does the separating function in the desired location where the bucket excavator is situated. The use of this screener reduces the number of trips for moving the soil, as it completes the soil screening with one load of the soil. Reduced fuel consumption is achieved with the use of the mechanized screener and there will be considerably less wear and tear and work time involved.

Referring now to FIG. 1, wire mesh 100 is illustrated. Wire mesh 100 is capable of separating large gravel from soil. In certain embodiments, wire mesh 100 can have a thickness of 1 to 10 centimeters depending on the job requirements. It is to be understood that wire mesh 100 can have an increased thickness and still fall within the scope of this invention.

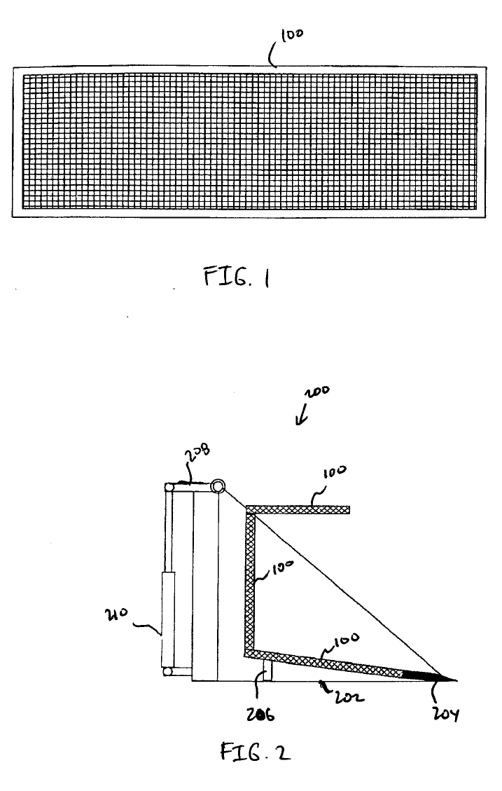

Referring now to FIG. 2, three panels of wire mesh 100 have been installed into bucket 202 of mechanized screener 200. In this embodiment, mechanized screener 200 can further be seen as including steel blade 204, leg 206, arm handle 208 and jack 210.

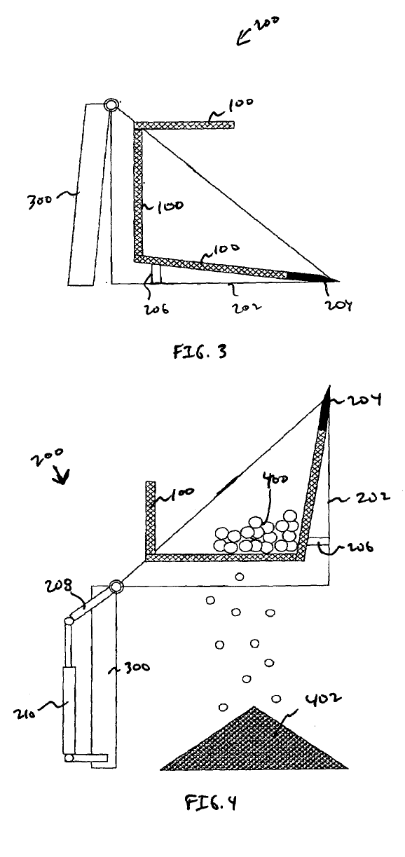

In this embodiment, the three panels of wire mesh 100 can be seen as forming a U-shaped enclosure within bucket 202. In this embodiment, steel blade 204 has been installed at the end of wire mesh 100. Steel blade 204 allows the end of the bucket to scoop up gravel and soil. In this embodiment, leg 206 can further be seen as securing the wire mesh 100 to bucket 202. While it is not illustrated, bucket 202 can be installed in a tractor or other road construction machinery. In an embodiment, bucket 202 can be installed into road construction machinery using attachment bar 300 (as shown in FIG. 3).

Referring now to FIG. 4, mechanized screener 200 can be seen as filtering gravel 400 from soil 402. Specifically, as shown in FIG. 4, jack 210 has pulled arm handle 208 down, thereby causing bucket 202 to lift off the ground. In this configuration, gravel 400 is trapped within the enclosure formed by the three panels of wire mesh 100 while soil 402 filters down to the ground. Once all of the soil has been filtered out, gravel 400 can be delivered to the desired site.

The use of this screener reduces the number of trips needed for moving the gravel and soil, as it completes the soil screening with one loading of gravel and soil.

As would be readily apparent to one having ordinary skill in the art, embodiments of mechanized screener 200 would likely include one or more of the following components: jack,

In an embodiment, different types of wire mesh 100 can easily be removably installed into bucket 202. In an embodiment, this may be accomplished by screwing and unscrewing the screen to bucket 202. In this manner, the screens used within mechanized screener 200 are readily interchangeable.

It is to be understood that mechanized screener 200 can be manufactured with different dimensions and in various forms for installation on different loaders and mechanical excavators.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modification that are suited to the particular use contemplated. It is intended that the scope of the invention be defined by the claims and their equivalents.

1. A mechanized screener, comprising:
a mechanized bucket adapted to pick up gravel and soil;
at least one wire mesh panel installed on the interior of the bucket; and
wherein the gravel and soil picked up by the bucket is separated within the bucket by the at least one wire mesh panel.

2. The mechanized screener of claim 1, wherein the mechanized bucket is installed onto a tractor.

3. The mechanized screener of claim 1, wherein at least three wire mesh panels form an enclosure within the interior of the bucket.

4. The mechanized screener of claim 1, wherein the mechanized screener comprises a jack, a pin, a spring, a steel blade and a hydraulic pump.

5. The mechanized screener of claim 1, wherein the mechanized screener comprises nuts, bolts, hinges, a hydraulic hose, and a switch.

6. The mechanized screener of claim 1, wherein the at least one wire mesh panel includes a thickness of 1 to 10 centimeters.

7. The mechanized screener of claim 1, wherein the one or more mesh panels are removably fastened to the bucket using screws.
